(19) United States
(12) Patent Application Publication
(10) Pub. No.: US 2015/0177748 A1
(43) Pub. Date: Jun. 25, 2015

(54) CONTROL SYSTEM AND METHOD FOR ENERGY SMART FAN

(71) Applicant: Chen-Mei LO, (US)

(72) Inventor: Tien-Bao YEH, New Taipei City (TW)

(21) Appl. No.: 14/563,093

(22) Filed: Dec. 8, 2014

(30) Foreign Application Priority Data
Dec. 19, 2013 (TW) 102223955
Jul. 30, 2014 (TW) 103125928

(51) Int. Cl. G05D 23/19; G05B 15/02

(52) U.S. Cl. CPC G05D 23/1917; G05B 15/02

(57) ABSTRACT

A control method includes pre-setting a PMV index range for an internal space in which a fan and an air conditioner is mounted and measuring a PMV value of the internal space; comparing the PMV value of the internal space with the PMV index range; and increasing a rotational speed of the fan when the PMV value of the internal space is greater than the PMV value of the PMV index region, and decreasing the rotational speed of the fan when the PMV value of the internal space is less than the PMV value of the PMV index region.

### BACKGROUND OF THE INVENTION

1. Field of the Invention

The invention relates to a control system and method for an energy smart fan, and more particularly to a control system and method for an energy smart fan comparing a PMV index of an internal space with a preset PMV index range to determine a rotational speed of the fan.

2. Description of the Related Art

Air conditioners are used to provide a comfortable environment, such as cooling a high temperature environment or heating a low temperature environment. Most conventional air conditioners can provide cool air and heat air to regulate a temperature of an internal space. Because the price of energy source increases, the cost of energy consumption for air conditioner becomes a burden for people's daily life.

It is very often to utilize other devices to reduce energy consumption of air conditioner. For example, a ceiling fan is often used in an office to provide air flows which reduces the energy consumption of an air conditioning system because utilization of a single air conditioning system may cause large energy consumption.

However, the fan devices for air conditioning system are usually regulated manually, which causes over heated or over cooled environment. Therefore, the energy consumption increases, and the over-heated or over-cooled environment makes people uncomfortable.

### BRIEF SUMMARY OF THE INVENTION

The object of the invention is to provide a control system and method for an energy smart fan. A rotational speed of a fan is regulated according to comparison of a PMV value of an internal space in which an air conditioner and the fan is mounted with a preset PMV index range to have a comfortable indoor temperature and save energy.

The invention provides a control system and method for an energy smart fan. The control method in accordance with an exemplary embodiment of the invention includes pre-setting a PMV index range for a internal space in which a fan and an air conditioner is mounted and measuring a PMV value of the internal space; comparing the PMV value of the internal space with the PMV index range; and increasing a rotational speed of the fan when the PMV value of the internal space is greater than the PMV value of the PMV index region, and decreasing the rotational speed of the fan when the PMV value of the internal space is less than the PMV value of the PMV index region.

In another exemplary embodiment, the fan has multiple control stages comprising a maximal speed stage and minimal speed stage, and a warning of temperature regulation is displayed on a remote controller when the fan is at the maximal speed stage or the minimal speed stage.

In yet another exemplary embodiment, the rotational speed of the fan is controlled by a signal transmitted from an information appliance to the fan via a wireless device, a recognition module, a signal control module and a signal converting module.

In another exemplary embodiment, the PMV index rage is from −0.5 to +0.5.

In yet another exemplary embodiment, the MPV index range is changed by an overcooling/overheating device.

The control system in accordance with an exemplary embodiment of the invention includes a PMV control system configured to set PMV index range, wherein the PMV index range is set to an intermediate range in which human feel comfortable; an environment detecting device measuring a PMV value of an internal space in which at least one fan and an air conditioner is mounted; and a comparing device connected to the fan and regulating a rotational speed of the fan according to comparison of the PMV value with the PMV index range.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of an embodiment of a control method for an energy smart fan of the invention;

FIG. 2 is a block diagram of a control system for an energy smart fan of the invention;

FIG. 3 is a block diagram of a control system for an energy smart fan of the invention along with sensors; and

FIG. 4 depicts an embodiment of a user interface for a control system for an energy smart fan of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Human's thermo-comfortability depend on six factors, temperature, air humidity, average radiation temperature, human activity content and cloth content. A predicted mean value (PMV) index estimating the human's thermo-comfortability is obtained according to the six factors. The PMV index ranges from −3 (the coldest) to +3 (the hottest), and the PMV index 0 means moderate. The PMV index is obtained by the following equation:

$$PMV = [ 0.303 {exp}^{( - 0.036 M )} + 0.028 ] \times \{ \begin{matrix}( M - W ) - \\ 3.05 [ 5.73 - 0.007 ( M - W ) - Pa ] - \\ 0.42 [ ( M - W ) - 58.15 ] - \\ 0.0173 M ( 5.87 - Pa ) + 0.0014 M ( 34 - ta ) - \\ {3.96}^{- 8} \times fcl \times [ {( tcl + 273 )}^{4} - {( MRT + 273 )}^{4} ] - \\ fcl \times hc \times ( tcl - ta )\end{matrix} \}$$

wherein exp=2.718281828, M: metabolic rates (W/m²), W: working rate (W/m²), Icl: cloth insulation (m²° C./W),) fcl: cloth surface area coefficient, ta: room temperature (° C.), mrt: average radiation temperature (° C.), va r: air flow speed (m/s), Pa: vapor partial pressure (Pa), hc: heat convection loss coefficient (W/m²° C.), tcl: cloth surface temperature (° C.).

The coefficient tcl, hc and fcl is calculated by equations 2.4, 2.5 and 2.6.

The average heat radiation temperature is calculated by the black body temperature (see equation 2.6) as described in McQuiston et al. [12].

t_{cl}=35.7−0.028×(M−W)−I_{cl}×{3.96×10⁻⁸f_{cl}×[(t_{cl}+273)⁴−(tᵣ+273)⁴]+f_{cl}h_{c}(t_{cl}−tₐ)} (2.4)

h_{c}=2.38×|t_{cl}−tₐ|^{0.25} or h_{c}=12.1vₐᵣ^{0.5} (2.5)

When I_{cl}<0≦0.78 m²kW⁻¹ then f_{cl}=1.00+1.29 I_{cl}

I_{cl}>0.78 m²kW⁻¹ then f_{cl}=1.05+0.645I_{cl}

Tᵣ⁴=T_{g}⁴+0.247×10⁹vₐᵣ^{1/2}(T_{g}−Tₐ) (2.6)

wherein, Tr: average radiation temperature (K), Ta: room temperature (K), Var: air flow speed (m/s), Tg: average black body temperature (K).

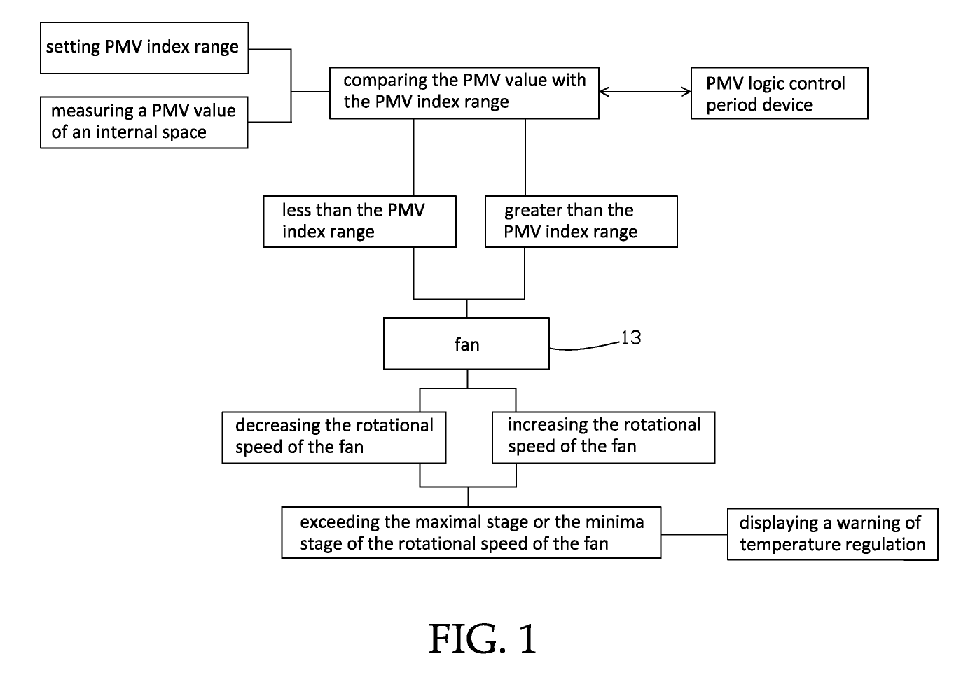

Referring to FIG. 1, a control method for a fan includes the following step:

A PMV index range is preset for an internal space in which a fan and an air conditioner is mounted and measuring a PMV value of the internal space. The range of PMV index is set from −0.5 to +0.5, and a PMV value of an internal space is measured. The PMV value of the internal space is compared with the PMV index range. A rotational speed of the fan is increased when the PMV value of the internal space is greater than the PMV value of the PMV index range (greater than +0.5), and the rotational speed of the fan is decreased when the PMV value of the internal space is less than the PMV value of the PMV index range (less than −0.5).

In this embodiment, PMV control conditions and multiple stages of rotational speed of the fan are pre-set, such as the first stage, the second stage, . . . , and the eighth stage. When the rotational speed of the fan. When the rotational speed of the fan is increased to the maximal stage, the eighth stage, or decreased to the minimal stage, the first stage, the PMV value cannot be further regulated by varying the rotational speed of the fan, a warning of temperature regulation is displayed on a remote controller.

In some embodiments, PMV value is obtained by calculating temperature field and thermo-comfortability through computational fluid dynamics. The visualization of flow field is accomplished by constructing boundary conditions and grids and calculating through computational fluid dynamics.

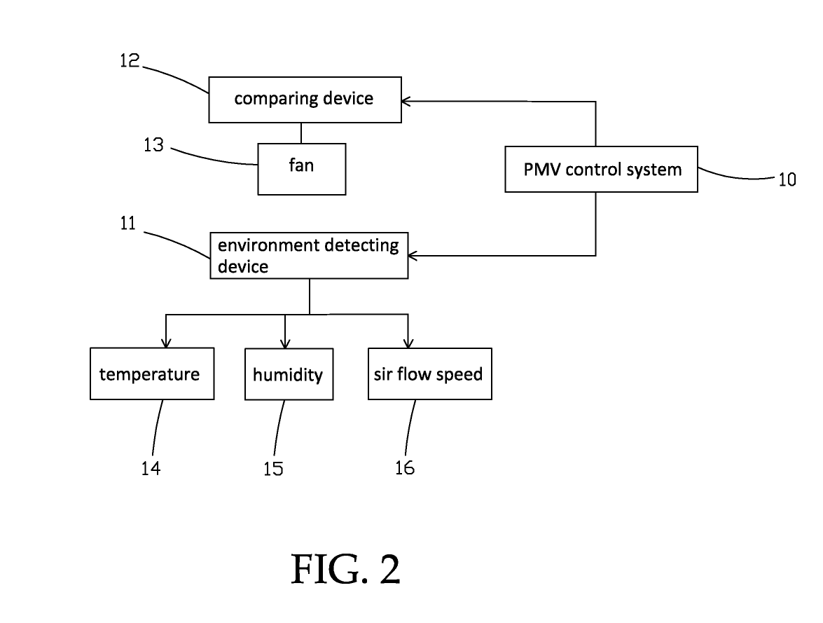

Referring to FIG. 2, a control system of the invention includes a PMV control system 10 presetting the PMV index range, an environment detecting device 11 measuring a PMV value of the internal space and a comparing device 12 connected to the fan 13 and regulating a rotational speed of the fan 13. The environment detecting device 11 can read data including temperature 14, humidity 15 and air flow speed 16.

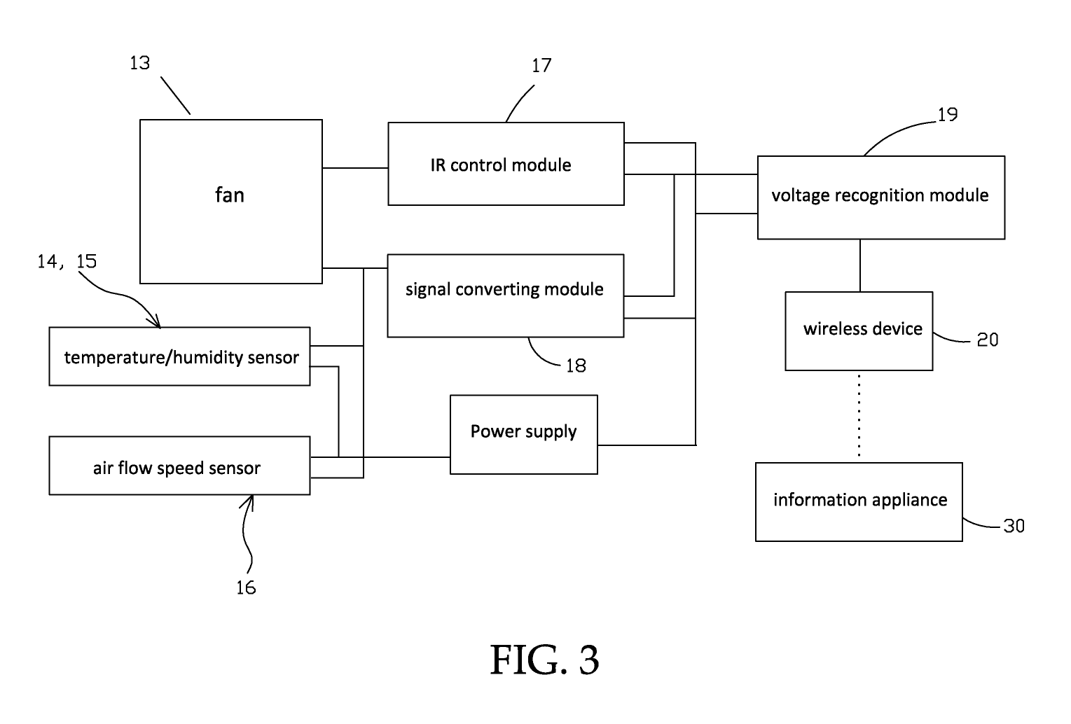

Referring to FIG. 3, the rotational speed of the fan 13 is controlled by a signal transmitted from an information appliance 30 to the fan 13 via a wireless device 20, a voltage recognition module 19 such as a bus RS 485, a signal control module 17 using IR and a signal converting module 18.

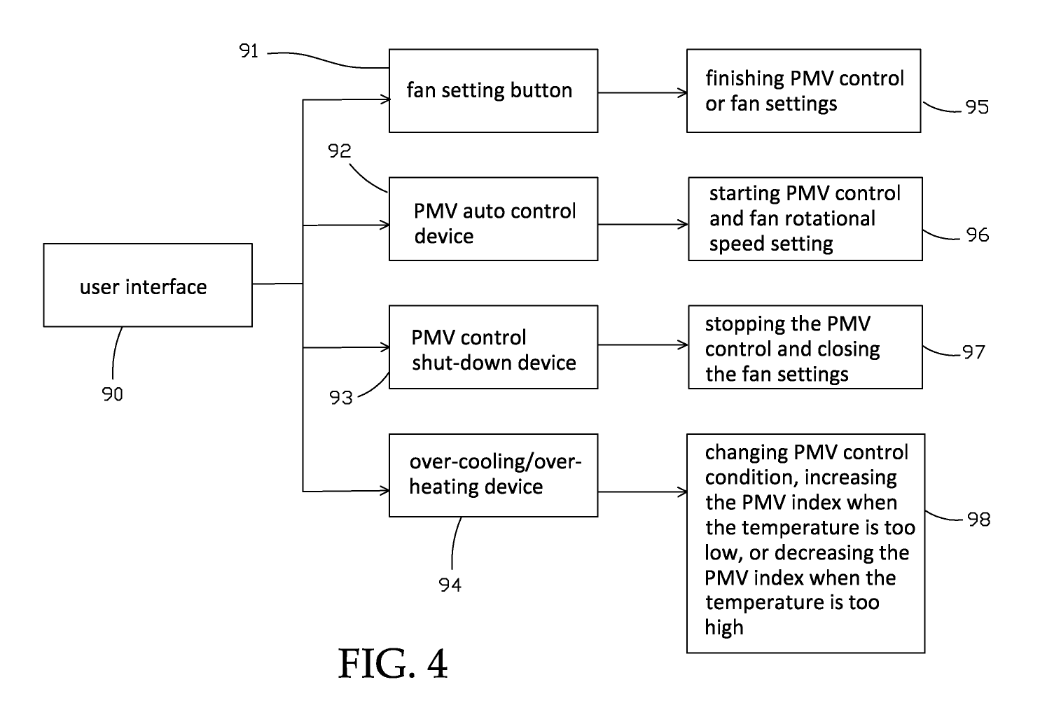

Referring to FIG. 4, a user interface 90 controlling the fan includes set buttons 91 turning the fan 13 on, turning the fan 13 off or controlling the stages of rotational speed so as to finish PMV control or fan settings 95, PMV auto-control device 92 starting PMV control and fan rotational speed setting 96, PMV control shut-down device 93 stopping the PMV control and closing the fan settings 97, and an over-cooling/over-heating device 94 changing PMV control condition 98, such as increasing the PMV index when the temperature is too low, or decreasing the PMV index when the temperature is too high.

The invention provides an energy smart fan control system and method. In an environment of multiple fans, the system can regulate automatically according to the indoor environment to keep air condition in a most comfortable condition and prevent the energy waste caused by overcooling or overheating.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control method for an energy smart fan, comprising:
pre-setting a PMV index range for an internal space in which a fan and an air conditioner is mounted and measuring a PMV value of the internal space;
comparing the PMV value of the internal space with the PMV index range; and
increasing a rotational speed of the fan when the PMV value of the internal space is greater than the PMV value of the PMV index range, and decreasing the rotational speed of the fan when the PMV value of the internal space is less than the PMV value of the PMV index range.

2. The control method as claimed in claim 1, wherein the fan has multiple control stages comprising a maximal speed stage and minimal speed stage, and a warning of temperature regulation is displayed on a remote controller when the fan is at the maximal speed stage or the minimal speed stage.

3. The control method as claimed in claim 1, wherein the rotational speed of the fan is controlled by a signal transmitted from an information appliance to the fan via a wireless device, a recognition module, a signal control module and a signal converting module.

4. The control method as claimed in claim 1, wherein the PMV index rage is from −0.5 to +0.5.

5. The control method as claimed in claim 2, wherein the PMV index rage is from −0.5 to +0.5.

6. The control method as claimed in claim 3, wherein the PMV index rage is from −0.5 to +0.5.

7. The control method as claimed in claim 1, wherein the MPV index range is changed by an overcooling/overheating device.

8. A control system for an energy smart fan, comprising:
a PMV control system configured to set PMV index range, wherein the PMV index range is set to an intermediate range in which human feel comfortable;
an environment detecting device measuring a PMV value of an internal space in which at least one fan and an air conditioner is mounted; and
a comparing device connected to the fan and regulating a rotational speed of the fan according to comparison of the PMV value with the PMV index range.

9. The control system as claimed in claim 8, wherein the fan has multiple control stages comprising a maximal speed stage and minimal speed stage, and a warning of temperature regulation is displayed on a remote controller when the fan is at the maximal speed stage or the minimal speed stage.

10. The control system as claimed in claim 8, wherein the rotational speed of the fan is controlled by a signal transmitted from an information appliance to the fan via a wireless device, a recognition module, a signal control module and a signal converting module.

11. The control system as claimed in claim 8, wherein the PMV index rage is from −0.5 to +0.5.

12. The control system as claimed in claim 8, wherein the MPV index range is changed by an overcooling/overheating device.
